(19) United States
(12) Patent Application Publication
(10) Pub. No.: US 2024/0013333 A1
(43) Pub. Date: Jan. 11, 2024

(54) METHOD OF HANDLING AN INCIDENT IN A MULTI-CLOUD ENVIRONMENT

(71) Applicant: MOTOROLA SOLUTIONS, INC., Chicago, IL (US)

(72) Inventors: PAWEL WILKOSZ, Wisniowa (PL); GRZEGORZ GUSTOF, Wisniowa (PL)

(21) Appl. No.: 17/810,998

(22) Filed: Jul. 6, 2022

(51) Int. Cl. G06Q 50/26; G06Q 10/06; G06Q 30/02; H04L 41/069

(52) U.S. Cl. CPC G06Q 50/265; G06Q 10/06315; G06Q 30/0201; H04L 41/069

(57) ABSTRACT

A process for handling an incident in a multi-cloud environment is provided. The process comprises receiving digital data associated with an incident, identifying cloud services to be executed in response to the incident, determining estimated usage levels at which the cloud services will be utilized in response to the incident, determining at least a first option of executing the cloud services and a second option of executing the cloud services that is different from the first option, estimating at least a cost of executing the cloud services according to the first option and a cost of executing the cloud services according to the second option, identifying a selected option by receiving the selected option from a user or choosing an option having the lowest estimated cost to be the selected option, and causing the cloud services to be executed according to the selected option.

### BACKGROUND OF THE INVENTION

Cloud computing relies on sharing of resources over a computer network and uses economies of scale to reduce computing costs. For example, customers, such as banks, credit card processing companies, or public safety agencies may execute applications on a computer network provided by a cloud provider. The use of such cloud-computing infrastructure can be a significant cost to the customers.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a system for minimizing the costs of handling an incident in a multi-cloud environment, in accordance with some embodiments.

FIG. 2 is a diagram showing a cloud-computing infrastructure, in accordance with some embodiments.

FIG. 3 is a device diagram showing a device structure of a computing device for minimizing costs of handling an incident in a multi-cloud environment an electronic, in accordance with some embodiments.

FIG. 4 is a flowchart of a method for minimizing the costs of handling an incident in a multi-cloud environment, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

To address the above-mentioned problem, a method, a computing device, and non-transitory, computer-readable storage medium for handling an incident in a multi-cloud environment are provided herein.

A first aspect of the present invention provides a method of handling an incident in a multi-cloud environment, comprising:
receiving digital data associated with an incident;
identifying cloud services to be executed in response to the incident;
determining estimated usage levels at which the cloud services will be utilized in response to the incident;
based on the identified cloud services and their estimated usage levels, determining at least a first option of executing the cloud services and a second option of executing the cloud services that is different from the first option, wherein the first option includes execution of at least one of the cloud services in a first cloud computing infrastructure and the second option includes execution of at least one of the cloud services in a second cloud computing infrastructure that is different from the first cloud computing infrastructure;
estimating at least a cost of executing the cloud services according to the first option and a cost of executing the cloud services according to the second option;
identifying a selected option by performing one of:
   i) presenting a list of options comprising at least the first option and the second option and at least the cost of executing the cloud services according to the first option and the cost of executing the cloud services according to the second option to a user and receiving the selected option from the user, or
   ii) choosing an option having the lowest estimated cost to be the selected option; and
causing the cloud services to be executed according to the selected option.

A second aspect of the present invention is a computing device comprising a communication unit and a controller configured to perform the method of handling an incident in a multi-cloud environment.

A third aspect of the present invention is a non-transitory, computer-readable storage medium having program instructions stored thereon that, when executed by one or more processors, enable the one or more processors to implement the of handling an incident in a multi-cloud environment.

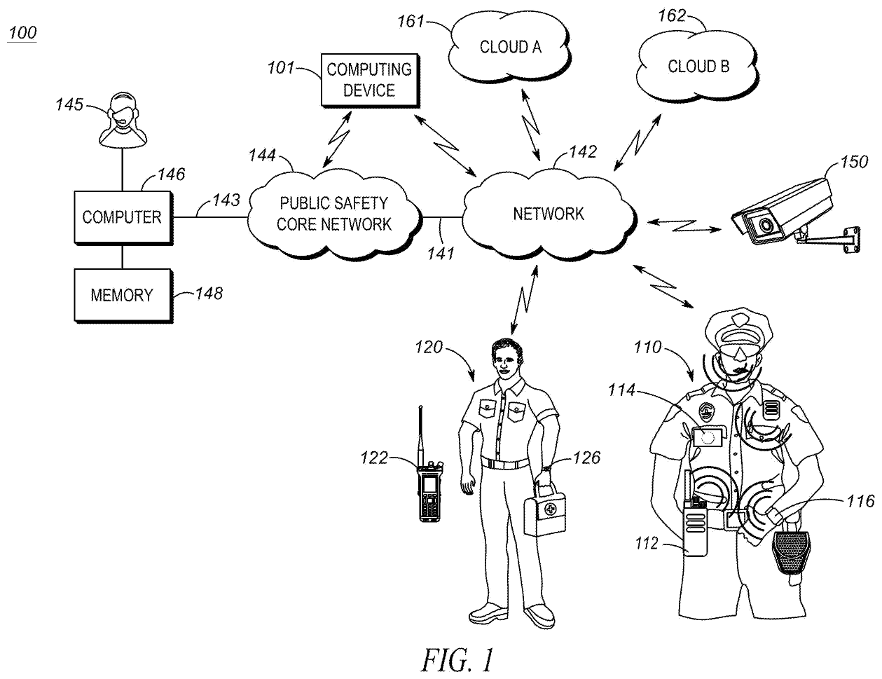

Turning now to the drawings, wherein numerals designate like components, FIG. 1 illustrates an operational environment for the present invention, a public-safety communication system 100.

As shown in FIG. 1, a public-safety officer 110 has an array of devices to use during the officer's shift. For example, the officer may have one radio 112 and one body-worn camera 114. He may also have other devices, like for example a smartwatch 116, a wireless microphone, smart handcuffs, a man-down sensor, etc. All devices pulled by the officer are configured to form a personal area network (PAN) by associating (pairing) with each other and communicating wirelessly among the devices. One or several devices may be configured with a digital assistant (virtual partner).

FIG. 1 illustrates also an additional user, a paramedic 120, with a respective additional set of same or similar devices as the officer 110, namely a radio 122 and a smartwatch 126. The user 120 may be geographically proximate to (or not geographically proximate to) the officer 110. In some embodiments, the user 120 may be a firefighter assigned to the same incident scene as the officer 110.

The public-safety communication system 100 further includes one or more communication networks 142, a public-safety core network 144, a computer 146 with an internal or external memory 148 storing databases (for example, a database of past incidents), and communication links 141, 143.

The communication network can be a radio access network (RAN). RAN includes typical RAN elements such as base stations, base station controllers (BSCs), routers, switches, and the like, arranged, connected, and programmed to provide wireless service to the user equipment in a manner known to those of skill in the relevant art. RAN may implement a direct-mode, conventional, or trunked land mobile radio (LMR) standard or protocol such as the European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RAN may implement a Long Term Evolution (LTE), LTE-Advanced, or 5G protocol including multimedia broadcast multicast services (MBMS) or single-site point-to-multipoint (SC-PTM) over which an open mobile alliance (OMA) push to talk (PTT) over cellular (OMA-PoC), a voice over IP (VoIP), an LTE Direct or LTE Device to Device (D2D) or a PTT over IP (PoIP) application may be implemented. In still further embodiments, RAN may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

In the example of FIG. 1, the radio 112 may form the hub of communication connectivity for the officer 110, through which other accessory devices such as the body-worn camera 114 or the smart watch 116 may communicatively couple. In order to communicate with and exchange video, audio, and other media and communications with the accessory devices, the radio 112 may contain one or more physical electronic ports (such as a Universal Serial Bus (USB) port, an Ethernet port, an audio jack, etc.) for direct electronic coupling with the accessory devices and/or may contain a short-range transmitter (e.g., in comparison to the long-range transmitter such as an LMR or Broadband transmitter) and/or transceiver for wirelessly coupling with the accessory devices. The short-range transmitter may be a Bluetooth, Zigbee, or NFC transmitter having a transmit range on the order of 0.01-100 meters or 0.1-10 meters. In other embodiments, the accessory devices may contain their own long-range transceivers and may communicate with one another and/or with the communication network 142 directly without passing through radio 112 or 122, over a respective wireless communication link(s).

In other embodiments, a hub may be formed by any other suitable computing and communication device configured to serve as a PAN primary device and to engage in wireless communication with the communication network 142 over the air interface as is known to those in the relevant art.

Public-safety core network 144 may include one or more packet-switched networks and/or one or more circuit-switched networks, and in general provides one or more public-safety agencies with any necessary computing and communication needs, transmitting any necessary public-safety-related data and communications.

It should also be noted that any one or more of the communication links 141, 143 could include one or more wireless communication links and/or one or more wired communication links.

The computer 146 comprises, or is part of, a computer-aided-dispatch center manned by a dispatcher 145, providing necessary dispatch operations. For example, computer 146 is a part of a dispatch console that comprises a graphical user interface that provides the dispatcher with information about public-safety officers or other users (paramedics, firefighters). Some of this information originates from accessory devices providing information to the radio 112, which forwards the information to the communication network 142 and ultimately to the computer 146. The computer 146 may be further configured to receive and store information about the incidents (current and past), the users and their assignments (which officers are engaged in a certain task), current location, etc. The information is preferably stored in a dedicated database in memory 148.

Many of the devices shown in FIG. 1 (such as the radio 112, the radio 122, and the dispatch console of the dispatcher 145) may be referred to as communication devices.

Oftentimes public-safety officers are surrounded by many devices such as street cameras, secure devices, mobile devices, PC/laptops, and any electronic equipment in government buildings, cars, motorbikes, or even streets. FIG. 1 illustrates a street camera 150 that can be part of a public-safety system or a city surveillance system. The camera 150 may communicate with the communication network 142 over the wired or wireless communication link.

The public-safety communication system 100 also includes a cloud computing infrastructure A 161 and a cloud computing infrastructure B 162. Cloud computing infrastructures are offered by the cloud providers to provide different services, for example, a communication application configured to process and/or conduct and/or manage a call between communication devices or a camera image analysis application configured to perform a face recognition procedure. Hereafter, the cloud computing infrastructure A 161 and a cloud computing infrastructure B 162 will be interchangeably referred to as the cloud A 161 and the cloud B 162 respectively. System 100 may also include more cloud computing infrastructures.

The public-safety communication system 100 further includes a computing device 101 that is in communication with the communication network 142 and the public-safety core network 144. Alternatively, the computing device 101 may be in communication with the memory 148 storing the databases and the cloud computing infrastructures A and B. Although depicted as a separate device, the computing device 101 can be also a part of the public-safety core network 144, the dispatch console, the communication network, one of the cloud computing infrastructures, or at other locations. Regardless of location and/or configuration, the computing device 101 is generally configured to perform the method of handling an incident in a multi-cloud environment according to the present invention.

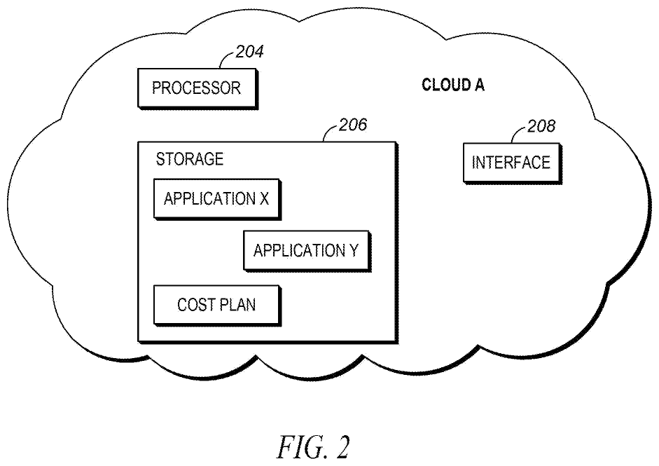

FIG. 2 depicts cloud A in accordance with an exemplary embodiment of the present invention. In the exemplary embodiment depicted in FIG. 2, cloud computing infrastructure A 161 includes an electronic processor 204, a storage device 206, and a communication interface 208. The electronic processor 204, the storage device 206, and the communication interface 208 communicate over one or more communication lines or buses. Wireless connections or a combination of wired and wireless connections are also possible.

The electronic processor 204 may include one or more processors. The electronic processor 204 obtains and provides information (for example, from the storage device 206 and/or the communication interface 208), and processes the information by executing one or more software instructions or modules capable of being stored, for example, in a random access memory (“RAM”) area of the storage device 206 or a read-only memory (“ROM”) of the storage device 206 or another non-transitory computer-readable medium (not shown). The software can include firmware, one or more applications, program data, filters, rules, one or more program modules, and other executable instructions.

The storage device 206 can include one or more non-transitory computer-readable media and may include a program storage area and a data storage area. The program storage area and the data storage area can include combinations of different types of memory, as described herein. In the embodiment illustrated, the storage device 206 stores, among other things, coded instructions for executing the application X (which can be a communication application), coded instructions for executing the application Y (which can be a camera image analysis application), and a price list (cost plan). The price list is a schedule of charges for the services offered by a cloud provider.

The communication interface 208 may include a transceiver (for example, an LTE modem, an FM transceiver, or a Wi-Fi or Ethernet transceiver) for communicating with the communication network 142. The communication interface 208 can also communicate with the computing device 101.

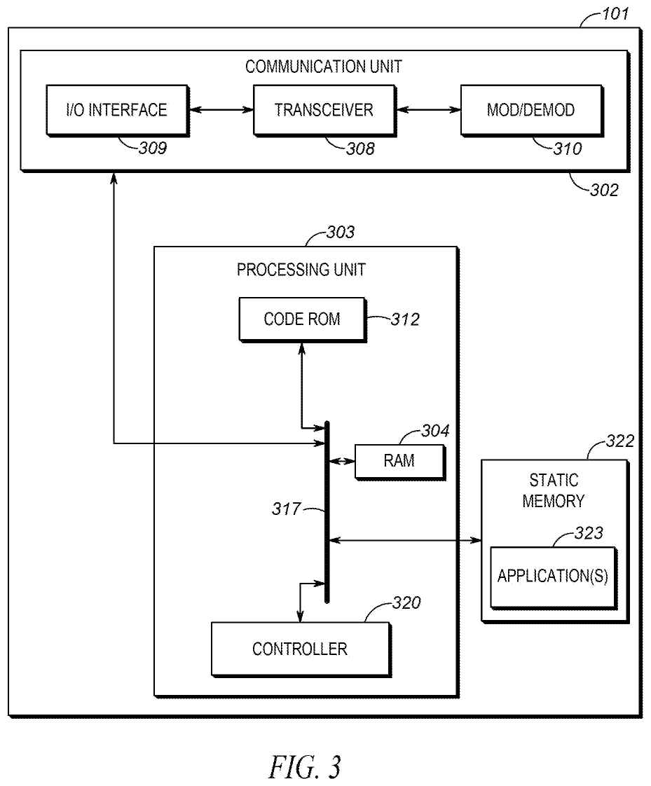

Attention is next directed to FIG. 3 which depicts a schematic block diagram of an example of the computing device 101. In general, the computing device 101 may comprise one or more servers and/or one or more cloud computing devices, and the like, configured to communicate with at least the communication network 142 and the public-safety core network 144.

As depicted, the computing device 101 comprises: a communication unit 302, a processing unit 303, a Random-Access Memory (RAM) 304, one or more wireless transceivers 308, one or more wired and/or wireless input/output (I/O) interfaces 309, a combined modulator/demodulator 310, a code Read Only Memory (ROM) 312, a common data and address bus 317, a controller 320, and a static memory 322 storing at least one application 323. Hereafter, at least one application 323 will be interchangeably referred to as the application 323.

While not depicted, computing device 101 may include one or more of an input device and a display screen and the like, a microphone (e.g., to receive voice commands) such that a user may interact with the computing device 101.

As shown in FIG. 3, the computing device 101 includes the communication unit 302 communicatively coupled to the common data and address bus 317 of the processing unit 303. The processing unit 303 may include the code Read Only Memory (ROM) 312 coupled to the common data and address bus 317 for storing data for initializing system components. The processing unit 303 may further include the controller 320 coupled, by the common data and address bus 317, to the Random-Access Memory 304 and the static memory 322.

The communication unit 302 may include one or more wired and/or wireless input/output (I/O) interfaces 309 which are configurable to communicate with at the communication network 142 and the public-safety core network 144. For example, the communication unit 302 may include one or more transceivers 308 and/or wireless transceivers for communicating with the communication network 142 and the public-safety core network 144. Tone or more transceivers 308 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication unit 302 may optionally include one or more wireline transceivers 308, such as an Ethernet transceiver, a USB (Universal Serial Bus) transceiver, or a similar transceiver configurable to communicate via a twisted pair wire, a coaxial cable, a fiber-optic link, or a similar physical connection to a wireline network. The transceiver 308 is also coupled to a combined modulator/demodulator 310.

The controller 320 may include ports (e.g., hardware ports) for coupling to other hardware components.

The controller 320 may include one or more logic circuits, one or more processors, one or more microprocessors, and/or the controller 320 may include one or more ASIC (application-specific integrated circuits) and one or more FPGA (field-programmable gate arrays), and/or another electronic device. In some examples, the controller 320 and/or the computing device 101 is not a generic controller and/or a generic device, but a device specifically configured to implement functionality for executing the cloud services in a multi-cloud environment based on cost. For example, in some examples, the computing device 101 and/or the controller 320 specifically comprises a computer-executable engine configured to implement functionality for executing the cloud services in a multi-cloud environment based on cost.

The static memory 322 is a non-transitory machine-readable medium that stores machine-readable instructions to implement one or more programs or applications. Example machine-readable media include a non-volatile storage unit (e.g. Erasable Electronic Programmable Read Only Memory (“EEPROM”), Flash Memory) and/or a volatile storage unit (e.g. random-access memory (“RAM”)). In the example of FIG. 3, programming instructions (e.g., machine-readable instructions) that implement the functional teachings of the computing device 101 as described herein are maintained, persistently, at the memory 322 and used by the controller 320 which makes appropriate utilization of volatile storage during the execution of such programming instructions.

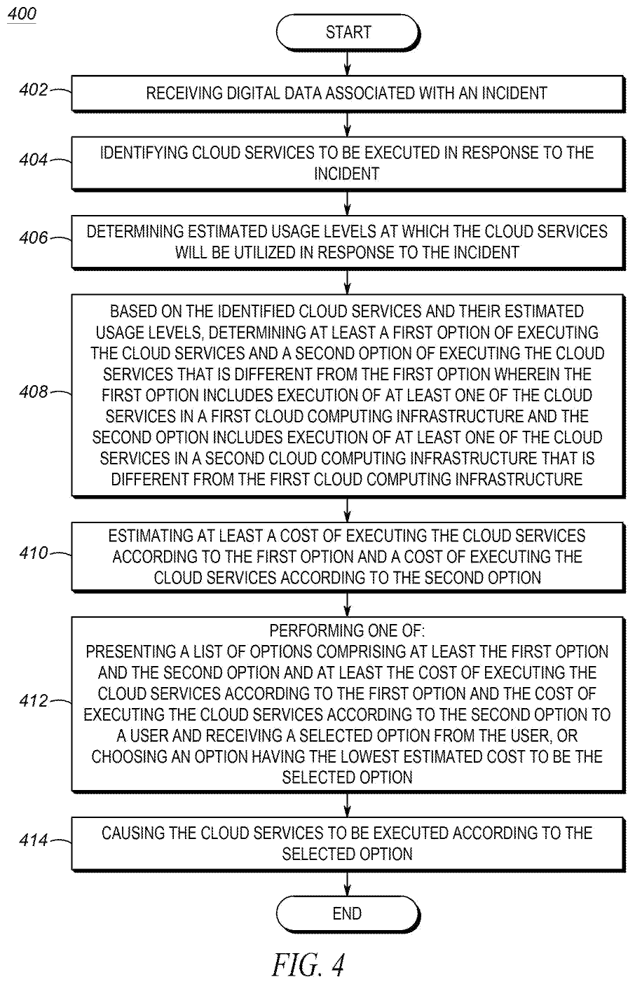

In particular, the memory 322 stores instructions corresponding to the at least one application 323 that, when executed by the controller 320, enable the controller 320 to implement functionality for executing the cloud services in a multi-cloud environment based on cost including, but not limited to, the blocks of the method outlined in FIG. 4.

In illustrated examples, when the controller 320 executes the one or more applications 323, the controller 320 is enabled to: receive a digital data associated with an incident; identify cloud services to be executed in response to the incident; determine estimated usage levels at which the cloud services will be utilized in response to the incident; based on the identified cloud services and their estimated usage levels, determine at least a first option of executing the cloud services and a second option of executing the cloud services that is different from the first option, wherein the first option includes execution of at least one of the cloud services in a first cloud computing infrastructure and the second option includes execution of at least one of the cloud services in a second cloud computing infrastructure that is different from the first cloud computing infrastructure; estimate at least a cost of executing the cloud services according to the first option and a cost of executing the cloud services according to the second option; perform one of presenting a list of options comprising at least the first option and the second option and at least the cost of executing the cloud services according to the first option and the cost of executing the cloud services according to the second option to a user and receiving a selected option from the user, or choosing an option having a lowest estimated cost to be the selected option; and cause the cloud services to be executed according to the selected option.

Moreover, an embodiment can be implemented as a non-transitory, computer-readable storage medium having program instructions stored thereon that when executed by the controller 320, enables the controller 320 to implement the functionality of handling an incident in a multi-cloud environment according to the present invention.

Attention is now directed to FIG. 4, which depicts a flowchart representative of a method 400 of handling an incident in a multi-cloud environment. The operations of method 400 of FIG. 4 correspond to machine-readable instructions that are executed by computing device 101, and specifically the controller 320 of the computing device 101. In the illustrated example, the instructions represented by the blocks of FIG. 4 are stored in the memory 322 for example, as the application 323. Method 400 of FIG. 4 is one way in which the controller 320 and/or the computing device 101 and/or the system 100 may be configured.

Method 400 of FIG. 4 need not be performed in the exact sequence as shown and likewise, various blocks may be performed in parallel rather than in sequence. Accordingly, the elements of method 400 are referred to herein as “blocks” rather than “steps.” Method 400 of FIG. 4 may be implemented on variations of the system 100 of FIG. 1, as well.

At block 402 the controller 320 and/or the computing device 101 receive, via the communication unit 302, digital data associated with an incident. The incident may be a public safety incident. The digital data associated with the incident may comprise one or more of: a type of the incident, a number of agencies assigned to the incident, a type and/or a number of responders assigned to the incident, a number of participants who participated in the incident, a type and/or a number of devices assigned to the incident, a geographical location of the incident, or a time of the day at which the incident occurred.

At block 404 the controller 320 and/or the computing device 101 identify cloud services to be executed in response to the incident. In some embodiments, cloud services to be executed in response to the incident may be provided by the dispatcher 145.

Cloud services may also be identified automatically based on historical data regarding past incidents, wherein historical data regarding past incidents may comprise data about past incidents having certain digital data the same as or similar to digital data associated with the incident.

The memory 322 may store instructions corresponding to an incident similarity criteria that, when executed by the controller 320, enables the controller 320 to retrieve data about the past incidents having certain digital data the same as or similar to digital data associated with the incident. Data about past incidents may be stored for example in the memory 148 of the computer 146. The incident similarity criteria may, for example, define incidents having certain digital data similar to digital data associated with the incident as incidents of the same type as the present incident and the number of first responders assigned to the incident falling within a range <X−2; X+2> or <80% of X; 120% of X>, wherein X is equal to the number of first responders assigned to the present incident.

At block 406 the controller 320 and/or the computing device 101 determine estimated usage levels at which the cloud services will be utilized in response to the incident.

Estimated usage levels at which the cloud services will be utilized in response to the incident may be calculated based on usage levels of cloud services during past incidents, retrieved as described above. Estimated usage levels may be calculated as, for example, the mean or median. Estimated usage levels may also be calculated based on a model stored in a memory 322.

At block 408 the controller 320 and/or the computing device 101, based on the identified cloud services and their estimated usage levels, determine at least a first option of executing the cloud services and a second option of executing the cloud services that is different from the first option. The first option includes the execution of at least one of the cloud services in the first cloud computing infrastructure and the second option includes the execution of at least one of the cloud services in a second cloud computing infrastructure that is different from the first cloud computing infrastructure. For example, the controller 320 and/or the computing device 101 may identify a cloud computing infrastructure A and a cloud computing infrastructure B, both offering some or all cloud services identified at block 404 and the desired bandwidth.

In some embodiments, only execution of all the identified cloud services in one cloud may be enabled. In such a case, the first option of executing the cloud services may be an execution of all services in the cloud A and the second option of executing the cloud services may be an execution of all services in the cloud B. In some embodiments, a mixed deployment may be enabled, wherein the mixed deployment is defined as execution of at least one of the services on the first cloud and at least one of the services on a cloud other than the first cloud. In such a case, the costs of mixed deployments have to be calculated and have to be taken into account. In such a case, besides the first option and the second option, there is also a third option of executing the cloud services comprising execution of an application X in the cloud A and application Y in the cloud B and a fourth option comprising execution of an application Y in the cloud A and application X in the cloud B, etc. The mixed deployment may also enable the execution of one type of service in the two cloud computing infrastructures simultaneously, for example, a camera image analysis application may be executed in cloud A for data from a first camera and in cloud B for data from a second camera.

At a block 410, the controller 320 and/or the computing device 101 estimate at least a cost of executing the cloud services according to the first option and a cost of executing the cloud services according to the second option based on the identified cloud services, their estimated usage levels, and the cost plans of the cloud computing infrastructure identified at the block 408. The controller 320 and/or the computing device 101 may estimate the cost of executing the cloud services according to every option identified at block 408.

The estimated cost of executing the cloud services according to the option may include a service initiation fee.

The estimated cost of executing the cloud services according to the option may include a periodic cost and/or a tier-change cost and/or any other cost related to executing a cloud service. For example, in a case where the usage level of a certain cloud service in a certain cloud computing infrastructure during a predefined period of time (for example a month) is close to a threshold above which a higher tier cost will be applied, the tier-change cost may be taken into account and the method may favor other options till the end of the said period of time, to avoid a change of tier.

At block 412 a selected option is identified. The controller 320 and/or the computing device 101 may automatically choose an option having the lowest estimated cost to be the selected option. In some embodiments, the selected option may be received from a user, wherein the controller 320 and/or the computing device 101 present to a user a list of options comprising at least the first option and the second option and at least the cost of executing the cloud services according to the first option and the cost of executing the cloud services according to the second option and receive the selected option from the user.

At block 414 the controller 320 and/or the computing device 101 cause the cloud services to be executed according to the selected option.

In some embodiments, the method further comprises an additional block (not shown). At the additional block, the controller 320 and/or the computing device 101 calculate a re-estimated cost of the first option and a re-estimated cost of the second option. Calculating the re-estimated costs may be performed periodically and/or be triggered in response to receiving new digital data associated with the incident. In response to determining that the option having the lowest re-estimated cost and the selected option do not match, the controller 320 and/or the computing device 101 may identify a second selected option and cause the cloud services to be executed according to the second selected option. Identification of the second selected option may be performed by either presenting the list of the options and at least the re-estimated cost of the first option and the re-estimated cost of the second option to the user and receiving a second selected option from the user or automatically choosing an option having a lowest re-estimated cost to be a second selected option.

### Example 1—Estimation

As an example of the above, consider the following example: A dispatcher sends the first responders to handle an incident—a street fight involving six participants. As it was reported that there is at least one person injured, besides 4 police officers, also 2 paramedics are assigned to handle the incident. There is one fixed camera with a field of view covering the location of the street fight that is assigned to the incident.

Digital data assigned with the incident received and/or generated by the dispatch center:
Incident type: street fight
Number of participants: 6
Number of injured: 2
Number of communication devices: 7 (4 police officers, 2 paramedics, 1 dispatcher)
Number of cameras assigned: 1

Based on the digital data assigned with the incident (and optionally also historical data), it is identified that cloud services to be executed in response to the incident are:
cloud-based communication application
camera image analysis application

Based on identified cloud services, options for executing the cloud services are determined. In this example, there are two cloud-based resources available—Cloud A and Cloud B, with their cost plans.

Cloud A Cost Plan
communication application:$8 per hour per device
camera image analysis: $100 per hour per camera

Cloud B Cost Plan
communication application: $10 per hour per device
camera image analysis: $100 per 1 GB (gigabyte) of analyzed data

Based on the cost plans it is determined that the number of communication devices, the estimated duration of the incident, and the estimated video data stream from the camera are necessary to calculate the cost of handling the present incident. The number of communication devices and cameras assigned to the incident is known. The duration and the amount of data for the video stream from the camera are estimated based on historical data.
Number of communication devices: 7 (4 police officers, 2 paramedics, 1 dispatcher)
Number of cameras assigned: 1
Estimated duration: 1 hour
Estimated video data stream from camera: 1 GB

Therefore the estimated cost of handling the present incident is:

Cost of Cloud A=7*$8+1*$100=$156

Cost of Cloud B=7*$10+1*$100=$170

The cheapest option is executing the cloud services on cloud A, therefore the cloud services to be executed in response to the incident are deployed on Cloud A.

### Example 2—Re-Estimation

During the handling of the incident, the dispatcher receives the information that the incident escalates and a group of 4 people gathers close to the incident scene. Therefore, 4 more police officers are sent to the incident scene and one more camera is assigned to handle the incident.

Current digital data associated with the incident received and/or generated by the dispatch center:
Incident type: street fight
Number of participants: 10
Number of injured: 2
Number of communication devices: 11 (8 police officers, 2 paramedics, 1 dispatcher)
Number of cameras assigned: 2

Based on current digital data, a re-estimated cost of handling the incident is calculated.

The duration and video stream size from the camera are re-estimated based on historical data relating to incidents similar to the incident described by the current set of digital data associated with the incident.
Number of communication devices: 11 (8 police officers, 2 paramedics, 1 dispatcher)
Number of cameras assigned: 2
Estimated duration: 1 hour
Estimated total video data stream from both cameras: 1 GB

Therefore, the recalculated cost of handling the present incident is:

Cost of Cloud A=11*$8+2*$100=$288

Cost of Cloud B=11*$10+1*$100=$210

The cheapest option is executing the cloud services on cloud B, therefore the cloud services to be executed in response to the incident are deployed on Cloud B.

### Example 3—Mixed Deployment

In some embodiments, the system enables a mixed deployment, wherein the mixed deployment is the deployment of at least one of the services on the first cloud and at least one of the services on a cloud other than the first cloud. In such a case, the costs of mixed deployments have to be calculated and have to be taken into account.

For the case described in example 2, the recalculated cost of all possible deployment options, including mixed options, is:

Cost of Cloud A=11*$8+2*$100=$288

Cost of Cloud B=11*$10+1*$100=$210

Cost of A(communication)+B(cameras)=11*$8+1*$100=$188

Cost of B(communication)+A(cameras)=11*$10+2*$100=$310

In this case, the cheapest option is to execute a cloud-based communication application on Cloud A and a camera image analysis application on Cloud B.

### Example 4—Cost of Re-Deployment

In some embodiments, the cost plan may comprise the cost of initiating certain services, which may affect the overall cost.

For example, the cost plan of Cloud B may comprise:
communication application deployment: $50
camera image analysis deployment: $110

Then the recalculated cost of all possible deployment options of Example 3 is:

Cost of Cloud A=11*$8+2*$100=$288

Cost of Cloud B=11*$10+$50+1*$100+$110=$370

Cost of A(communication)+B(cameras)=11*$8+1*$100+$110=$298

Cost of B(communication)+A(cameras)=11*$10+$50+2*$100=$360

In this case, the cheapest option is to continue using Cloud A.

However, for some incidents, the cost of initiating a service may be compensated by a lower cost of usage for a longer time.

For example if the estimated duration of incident from Example 2 is 2 hours and the estimated total video data stream from both cameras is 2 GB, then the estimated cost of handling the incident is as follows:

Cost of Cloud A=11*$8+4*$100=$488

Cost of Cloud B=11*$10+$50+2*$100+$110=$470

Cost of A(communication)+B(cameras)=11*$8+2*$100+$110=$398

Cost of B(communication)+A(cameras)=11*$10+$50+4*$100=$560

In this case, the cheapest option is to execute a cloud-based communication application on Cloud A and the camera image analysis application on Cloud B.

### CONCLUSION

In accordance with the foregoing, a method, computer device, and non-transitory, computer-readable storage medium is disclosed, for handling an incident in a multi-cloud environment are provided herein.

As a result of the foregoing, and in some embodiments, cloud services to be executed in response to the incident are identified and their estimated usage levels are determined. Thanks to these data, the cheapest option of executing cloud services in the cloud computing infrastructures may be determined and deployed. Other features and advantages are possible as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment, the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal, or a mechanical element depending on the particular context.

It will be appreciated that some embodiments may be comprised of one or more generic or specialized processors (or “processing devices”) such as microprocessors, digital signal processors, customized processors and field-programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application-specific integrated circuits (ASICs), in which each function or some combinations of certain of the functions are implemented as custom logic. Of course, a combination of the two approaches could be used.

Moreover, an embodiment can be implemented as a computer-readable storage medium having computer-readable code stored thereon for programming a computer (e.g., comprising a processor) to perform a method as described and claimed herein. Any suitable computer-usable or computer-readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The computer program instructions may also be loaded onto a computer or other programmable data processing apparatus that may be on or off-premises or may be accessed via the cloud in any of software as a service (SaaS), platform as a service (PaaS), or infrastructure as a service (IaaS) architecture.

It is contemplated that any part of any aspect or embodiment discussed in this specification can be implemented or combined with any part of any other aspect or embodiment discussed in this specification.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method of handling an incident in a multi-cloud environment, comprising:
receiving digital data associated with an incident;
identifying cloud services to be executed in response to the incident;
determining estimated usage levels at which the cloud services will be utilized in response to the incident;
based on the identified cloud services and their estimated usage levels, determining at least a first option of executing the cloud services and a second option of executing the cloud services that is different from the first option, wherein the first option includes execution of at least one of the cloud services in a first cloud computing infrastructure and the second option includes execution of at least one of the cloud services in a second cloud computing infrastructure that is different from the first cloud computing infrastructure;
estimating at least a cost of executing the cloud services according to the first option and a cost of executing the cloud services according to the second option;
identifying a selected option by performing one of:
iii) presenting a list of options comprising at least the first option and the second option and at least the cost of executing the cloud services according to the first option and the cost of executing the cloud services according to the second option to a user and receiving the selected option from the user, or
iv) choosing an option having the lowest estimated cost to be the selected option; and
causing the cloud services to be executed according to the selected option.

2. The method according to claim 1, wherein digital data associated with the incident comprises one or more of: a type of the incident, a number of agencies assigned to the incident, a type and/or a number of responders assigned to the incident, a number of participants who participated in the incident, a type and/or a number of devices assigned to the incident, a geographical location of the incident, or a time of the day at which the incident occurred.

3. The method according to claim 1, wherein cloud services to be executed in response to the incident are identified and/or their estimated usage levels are determined based on historical data regarding past incidents.

4. The method according to claim 3, wherein historical data regarding past incidents comprises data about past incidents having certain digital data the same as or similar to digital data associated with the incident.

5. The method according to claim 1, wherein the estimated cost of executing the cloud services according to the first option and/or the estimated cost of executing the cloud services according to the second option includes a service initiation fee.

6. The method according to claim 1, wherein the estimated cost of executing the cloud services according to the first option and/or the estimated cost of executing the cloud services according to the second option includes a periodic cost and/or a tier-change cost.

7. The method according to claim 1, further comprising:
calculating a re-estimated cost of the first option and a re-estimated cost of the second option, wherein calculating the re-estimated costs is performed periodically and/or is triggered in response to receiving new digital data associated with the incident;
in response to determining that an option having the lowest re-estimated cost and the selected option do not match, identifying a second selected option by performing one of:
i) presenting the list of the options and at least the re-estimated cost of the first option and the re-estimated cost of the second option to the user and receiving the second selected option from the user, or
ii) choosing the option having a lowest re-estimated cost to be the second selected option;
causing the cloud services to be executed according to the second selected option.

8. The method according to claim 1, wherein the incident is a public safety incident.

9. A computing device comprising:
a communication unit; and
a controller configured to:
receive digital data associated with an incident;
identify cloud services to be executed in response to the incident;
determine estimated usage levels at which the cloud services will be utilized in response to the incident;
based on the identified cloud services and their estimated usage levels, determine at least a first option of executing the cloud services and a second option of executing the cloud services that is different from the first option, wherein the first option includes execution of at least one of the cloud services in a first cloud computing infrastructure and the second option includes execution of at least one of the cloud services in a second cloud computing infrastructure that is different from the first cloud computing infrastructure;
estimate at least a cost of executing the cloud services according to the first option and a cost of executing the cloud services according to the second option;
identify a selected option by performing one of:
i) presenting a list of options comprising at least the first option and the second option and at least the cost of executing the cloud services according to the first option and the cost of executing the cloud services according to the second option to a user and receive the selected option from the user, or
ii) choosing an option having the lowest estimated cost to be the selected option; and
cause the cloud services to be executed according to the selected option.

10. The computing device according to claim 9, wherein digital data associated with the incident comprises one or more of: a type of the incident, a number of agencies assigned to the incident, a type and/or a number of responders assigned to the incident, a number of participants who participated in the incident, a type and/or a number of devices assigned to the incident, a geographical location of the incident, or a time of the day at which the incident occurred.

11. The computing device according to claim 9, wherein cloud services to be executed in response to the incident are identified and/or their estimated usage levels are determined based on historical data regarding past incidents.

12. The computing device according to claim 11, wherein historical data regarding past incidents comprises data about past incidents having certain digital data the same as or similar to digital data associated with the incident.

13. The computing device according to claim 9, wherein the estimated cost of executing the cloud services according to the first option and/or the estimated cost of executing the cloud services according to the second option includes a service initiation fee.

14. The computing device according to claim 9, wherein the estimated cost of executing the cloud services according to the first option and/or the estimated cost of executing the cloud services according to the second option includes a periodic cost and/or a tier-change cost.

15. The computing device according to claim 9, wherein the controller is further configured to:
calculate a re-estimated cost of the first option and a re-estimated cost of the second option, wherein calculating the re-estimated costs is performed periodically and/or is triggered in response to receiving new digital data associated with the incident;
in response to determining that an option having the lowest re-estimated cost and the selected option do not match, identify a second selected option by performing one of:
present the list of the options and at least the re-estimated cost of the first option and the re-estimated cost of the second option to the user and receive the second selected option from the user, or
choose the option having a lowest re-estimated cost to be the second selected option; and
cause the cloud services to be executed according to the second selected option.

16. The computing device according to claim 9, wherein the incident is a public safety incident.

17. A non-transitory, computer-readable storage medium having program instructions stored thereon that when executed by one or more processors, enable the one or more processors to implement: receiving digital data associated with an incident;
identifying cloud services to be executed in response to the incident;
determining estimated usage levels at which the cloud services will be utilized in response to the incident;
based on the identified cloud services and their estimated usage levels, determining at least a first option of executing the cloud services and a second option of executing the cloud services that is different from the first option, wherein the first option includes execution of at least one of the cloud services in a first cloud computing infrastructure and the second option includes execution of at least one of the cloud services in a second cloud computing infrastructure that is different from the first cloud computing infrastructure;
estimating at least a cost of executing the cloud services according to the first option and a cost of executing the cloud services according to the second option;
identifying a selected option by performing one of:
i) presenting a list of options comprising at least the first option and the second option and at least the cost of executing the cloud services according to the first option and the cost of executing the cloud services according to the second option to a user and receiving the selected option from the user, or
ii) choosing an option having a lowest estimated cost to be the selected option; and
causing the cloud services to be executed according to the selected option
